(19) United States
(12) Patent Application Publication
(10) Pub. No.: US 2026/0194224 A1
(43) Pub. Date: Jul. 9, 2026

(54) ASSEMBLED FAN LIGHT

(71) Applicant: Jinliang Liu, Shenzhen (CN)

(72) Inventor: Jinliang Liu, Shenzhen (CN)

(21) Appl. No.: 19/553,307

(22) Filed: Feb. 28, 2026

(51) Int. Cl. F21V 33/00

(52) U.S. Cl. CPC F21V 33/0096

(57) ABSTRACT

An assembled fan light is provided, including a central assembly which includes a housing and a control mechanism mounted inside the housing, where the housing can be connected to an external mounting structure; a fan blade assembly detachably in pivotal connection to the control mechanism; and a light frame assembly including at least two assembling light frames and at least two connection frames. Each assembling light frame includes an arc-shaped light frame body and two assembling bodies which extend towards a circle center of an arc respectively from two ends of the light frame body. The at least two light frame bodies are connected in sequence end-to-end to form a whole circle structure. Two correspondingly adjacent assembling bodies of the at least two assembling light frames are adaptively connected to each other and are detachably connected to one end of one of the connection frames.

### TECHNICAL FIELD

The present disclosure relates to the technical field of lighting electrical appliances, and more specifically relates to an assembled fan light.

### BACKGROUND

With the rapid development of the times and the improvement of the living standard, there are more and more types of household appliances.

At present, a fan light has become a widely used household appliance for lighting, which has both a lighting function and a fan function. For most of existing fan lights, protective covers or protective housings are added outside fan blades to play a role in protection and make the appearance more beautiful. The existing protective housings and protective covers are mostly of integrated structures, so that the fan lights have large packaging volumes, high transportation costs, and single styles. The products are easily damaged because they are unfolded during transportation. Since some assembled fan lights are disassembled into separate parts for packaging, the packaging volume is small, but customers have to assemble these separate parts by themselves, and it is inconvenient to use. In addition, there is an assembling gap after the parts are assembled, making light sources discontinuous, and the user experience is poor. There is a need for an improved technical solution.

### SUMMARY

In view of the above content, the present disclosure aims to at least solve one of the technical problems in the prior art. To this end, the present disclosure provides an assembled fan light. A fan blade assembly is detachably connected to a central assembly, and a light frame assembly is configured as a detachable assembled structure. Assembling bodies of assembling light frames are assembled with each other, and light frame bodies are connected and assembled end-to-end to form a continuous whole circle structure to facilitate mounting and removal. This enhances storage convenience and transportation safety of the assembled fan light. Meanwhile, difficulty of operations of a user will not be increased. The assembling light frames are continuous and intact and achieve a good lighting effect. The assembled fan light has a simple structure and is suitable for being applied to large-scale industrial production.

To this end, in a first aspect, an embodiment of the present disclosure provides an assembled fan light, including:
a central assembly including a housing and a control mechanism mounted inside the housing, where the housing is capable of being connected to an external mounting structure;
a fan blade assembly detachably in pivotal connection to the control mechanism; and
a light frame assembly including at least two assembling light frames and at least two connection frames, where each assembling light frame includes an arc-shaped light frame body and two assembling bodies which extend towards a circle center of an arc respectively from two ends of the light frame body; the at least two light frame bodies are connected in sequence end-to-end to form a whole circle structure; two correspondingly adjacent assembling bodies of the at least two assembling light frames are adaptively connected to each other and are detachably connected to one end of one of the connection frames; and another end of the connection frame is detachably connected to the housing.

Preferably, each light frame body includes two end walls located at two ends, a side wall connected between the two end walls, and a light board with a lower side adaptively connected to the side wall and the two end walls; the end walls of each light frame body are correspondingly connected to the end walls of another light frame body; and the assembling bodies are connected to an end portion of the side wall and are flush with the end walls corresponding to the assembling bodies.

Preferably, the side wall of each light frame body includes a first side wall located on an inner side and a second side wall opposite to the first side wall; each light frame body further includes a cover plate with an upper side covering the first side wall, the second side wall, and the two end walls; a lower side of the light board is adaptively connected to the first side wall, the second side wall, and the two end walls; and the assembling bodies are connected to an end portion of the first side wall and are flush with the end walls corresponding to the assembling bodies.

Preferably, the first side wall is provided with a wire passing opening corresponding to one assembling body; the assembling body is configured as a hollow structure; the light board is provided with a terminal cable corresponding to the wire passing opening; and the terminal cable is electrically connected to the control mechanism via the wire passing opening, the assembling body, and a corresponding one of the connection frames.

Preferably, the light frame assembly further includes a lampshade correspondingly arranged on the lower side of the light board; and/or,
the end walls of the assembling light frames are abutted with each other; the assembling bodies of the light frame bodies are clamped with each other; and the light boards of the light frame bodies are abutted with each other.

Preferably, end portions of the light frame bodies are abutted with each other, and the assembling bodies are clamped with each other.

Preferably, each assembling body includes an assembling wall flush with an end portion of the light frame body corresponding to the assembling body; the assembling wall is provided with a clamping structure; and the assembling walls of the assembling bodies are clamped with each other through the clamping structures.

Preferably, each connection frame is configured as a hollow structure, and the two assembling bodies corresponding to the connection frame are adaptively connected and assembled to the connection frame.

Preferably, the connection frame is provided with a mounting port facing a corresponding one of the light frame bodies; a middle portion of the mounting port inwards extends to form a limiting strip; and two sides of the limiting strip are respectively received within the two assembling bodies corresponding to the connection frame.

Preferably, the two assembling bodies corresponding to the connection frame are assembled with each other to jointly form a mounting hole; the connection frame is provided with a through hole corresponding to the mounting hole; a locking member passes through the through hole and is locked to the mounting hole; or,
the assembling bodies are provided with mounting holes; the connection frame is provided with a through hole corresponding to the mounting holes; and a locking member passes through the through hole and is locked to the mounting holes.

According to the assembled fan light provided in the present disclosure, in one aspect, the fan blade assembly is configured to be detachably connected to the central assembly, thus implementing convenient mounting and removal of the fan blade assembly. In another aspect, the light frame assembly is formed into an intact circular continuous assembled structure by the assembling light frames and is assembled and connected to the central assembly through the connection frames, thus implementing convenient mounting and removal of the light frame assembly. The structure is simple, and the operation is convenient. During use, light sources of the light frames are continuous, thus providing a good user experience.

### BRIEF DESCRIPTION OF THE DRAWINGS

FIG. 1 is a schematic diagram of a three-dimensional structure of an assembled fan light provided in an embodiment of the present disclosure;

FIG. 2 is a schematic diagram of a three-dimensional structure of disassembling of some elements of the assembled fan light in FIG. 1 in a first state;

FIG. 3 is an enlarged view of part A in FIG. 1;

FIG. 4 is a schematic diagram of a three-dimensional structure of disassembling of some elements of the assembled fan light in FIG. 1 in a second state;

FIG. 5 is an enlarged view of part B in FIG. 4; and

FIG. 6 is a schematic diagram of a three-dimensional structure of the assembled fan light in FIG. 1 in another viewing angle.

### DETAILED DESCRIPTION OF THE EMBODIMENTS

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

The following disclosure provides many different embodiments or examples to implement different structures of the present disclosure. In order to simplify the disclosure of the present disclosure, components and settings of specific examples are described below. Certainly, they are merely examples and are not intended to limit the present disclosure. In addition, the present disclosure may repeatedly refer to numbers and/or letters in different examples. Such repetition is for purposes of simplicity and clarity and does not itself indicate a relationship between the various embodiments and/or settings discussed. In addition, the present disclosure provides examples of various specific processes and materials, but a person of ordinary skill in the art will recognize the application of other processes and/or the use of other materials.

The present disclosure aims to provide an assembled fan light 100, which is applied to indoor decoration and has a lighting function and a fan function.

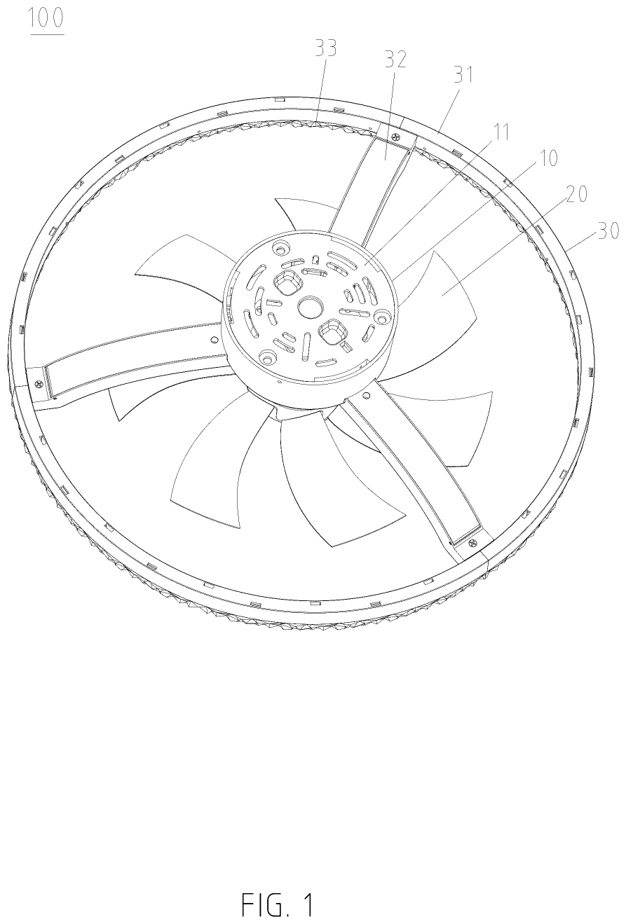

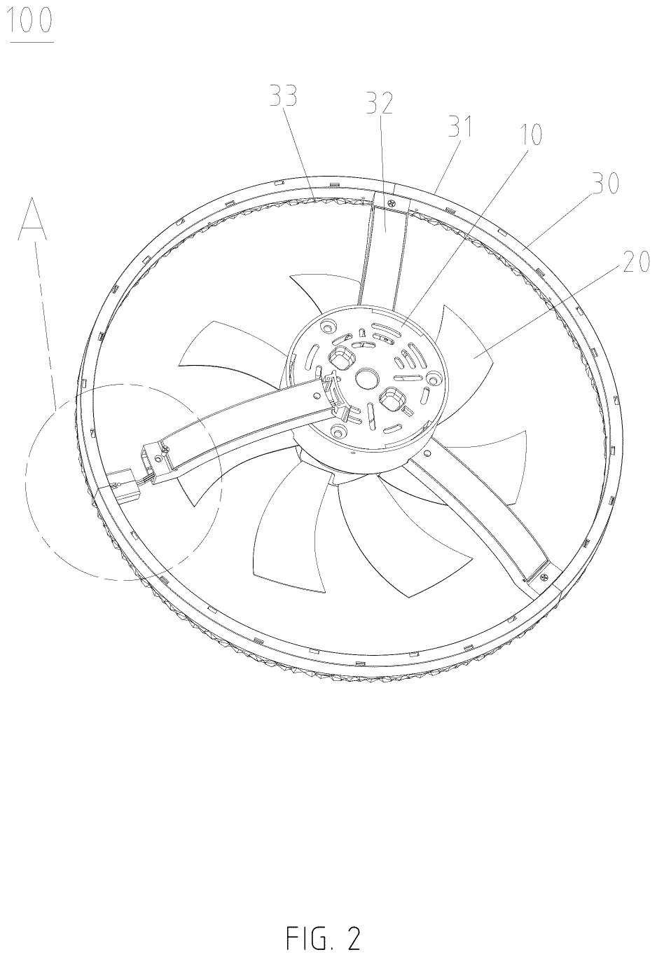

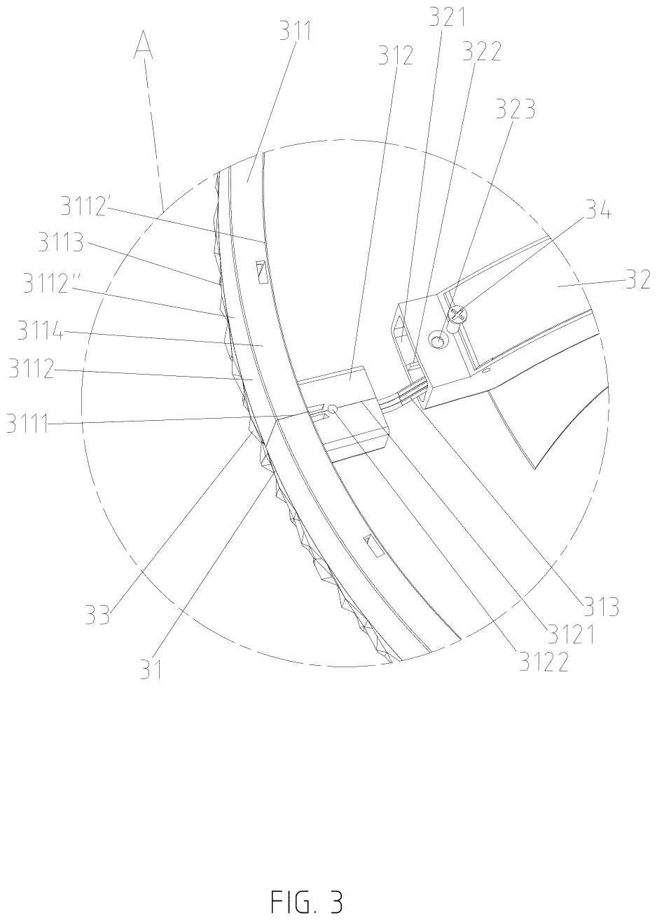

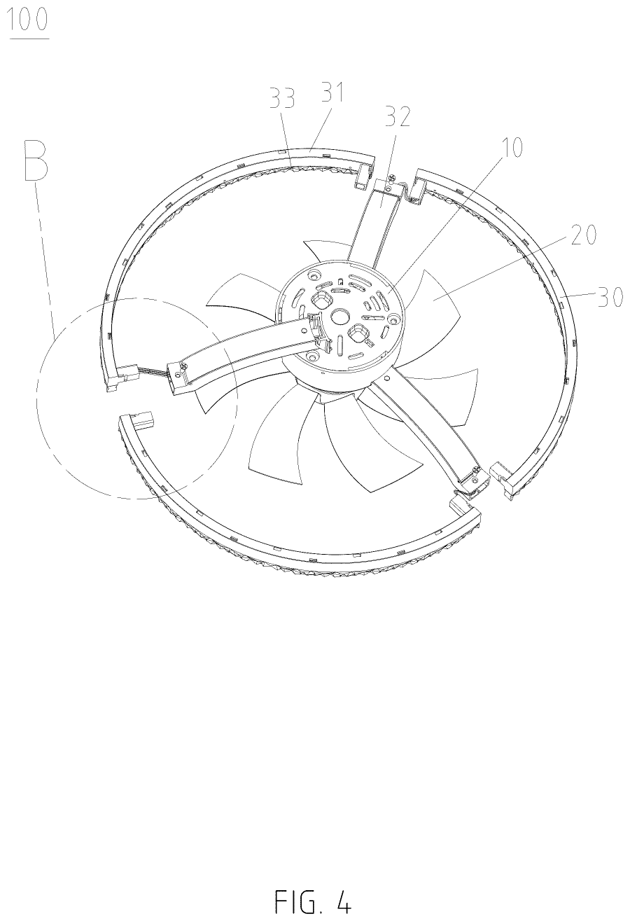

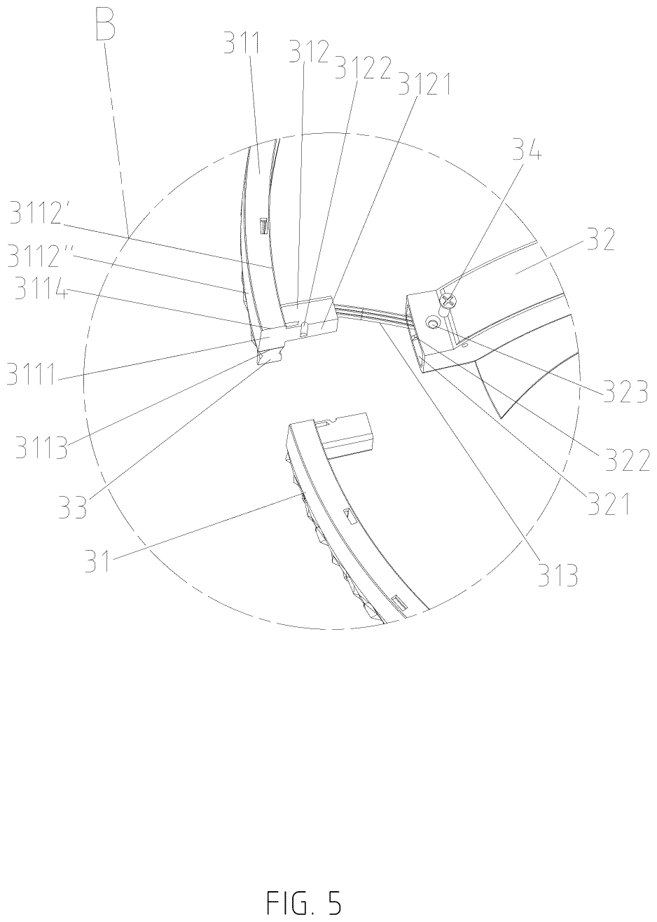

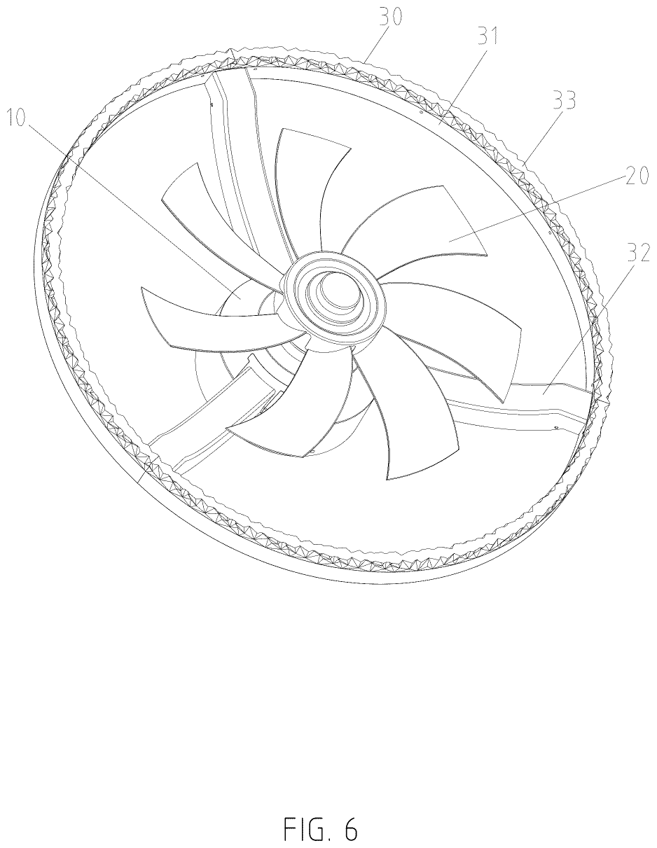

Referring to FIG. 1 to FIG. 6, the assembled fan light 100 includes:
a central assembly 10, which includes a housing 11 and a control mechanism (not shown) mounted inside the housing 11, where the housing 11 can be connected to an external mounting structure;
a fan blade assembly 20, which is detachably in pivotal connection to the control mechanism; and
a light frame assembly 30 including at least two assembling light frames 31 and at least two connection frames 32, where each assembling light frame 31 includes an arc-shaped light frame body 311 and two assembling bodies 312 which extend towards a circle center of an arc respectively from two ends of the light frame body 311; the at least two light frame bodies 311 are connected in sequence end-to-end to form a whole circle structure; two correspondingly adjacent assembling bodies 312 of the at least two assembling light frames 31 are adaptively connected to each other and are detachably connected to one end of one of the connection frames 32; and another end of the connection frame 32 is detachably connected to the housing 11.

In this embodiment, the light frame assembly 30 and the fan blade assembly 20 are respectively detachably connected to the central assembly. Furthermore, the light frame assembly 30 is detachably assembled to form a continuous light source light frame structure, so that the structure is simple, it is convenient for mounting and removal, and the display effect is good.

Further, each light frame body 311 includes two end walls 3111 located at two ends, a side wall 3112 connected between the two end walls 3111, and a light board 3113 with a lower side adaptively connected to the side wall 3112 and the two end walls 3111; the end walls 3111 of each light frame body 311 are correspondingly connected to the end walls 3111 of another light frame body 311; and the assembling bodies 312 are connected to an end portion of the side wall 3112 and are flush with the end walls 3111 corresponding to the assembling bodies 312. The light boards 3113 can be connected end-to-end to avoid a gap generated between light sources.

In this embodiment, circumferential sides of the light frame bodies 311 are configured as frame body structures, and entire lower sides of the light frame bodies 311 are configured as the light boards 3113. When a plurality of light frame bodies 311 are assembled, the light boards 3113 on the lower sides are connected to each other to form a continuous overall light source, so that the display effect is good. Specifically, a plurality of light-emitting diode (LED) display units are arranged on the light boards 3113 to form continuous LED light strip structures.

Further, the side wall 3112 of each light frame body 311 includes a first side wall 3112′ located on an inner side and a second side wall 3112″ opposite to the first side wall 3112′. Each light frame body 311 further includes a cover plate 3114 with an upper side covering the first side wall 3112′, the second side wall 3112″, and the two end walls 3111. A lower side of the light board 3113 is adaptively connected to the first side wall 3112′, the second side wall 3112″, and the two end walls 3111. The assembling bodies 312 are connected to an end portion of the first side wall 3112′ and are flush with the end walls 3111 corresponding to the assembling bodies 312.

In this embodiment, upper sides of the frame body structures of the light frame bodies 311 are closed. Specifically, the cover plates 3114 are configured as detachable structures. This facilitates protection of the light frame bodies and the light boards 3113, or maintenance of the light boards 3113.

Further, the first side wall 3112′ is provided with a wire passing opening (not shown) corresponding to one assembling body 312. The assembling body 312 is configured as a hollow structure. The light board 3113 is provided with a terminal cable 313 corresponding to the wire passing opening. The terminal cable 313 is electrically connected to the control mechanism via the wire passing opening, the assembling body 312, and a corresponding one of the connection frames 32.

Further, the light frame assembly 30 further includes a lampshade 33 correspondingly arranged on the lower side of the light board 3113. In this embodiment, the lampshade 33 is added on the lower side of the light board 3113, which further enhances continuity of light sources. It can be understood that the lampshade 33 is correspondingly configured as a structure corresponding to a shape of the light frame body 311. That is, a plurality of lampshades 33 are connected end-to-end. The plurality of lampshades 33 can abut against each other by being respectively connected and fitted to the light frame bodies 311, or connection structures can be added between the lampshades 33 to assemble them into a whole, and then the whole is connected and fitted to an overall structure of the light frame bodies 311.

Further, the end walls 3111 of the assembling light frames are abutted with each other. The assembling bodies 312 of the light frame bodies are clamped with each other. The light boards 3113 of the light frame bodies are abutted with each other. In this embodiment, in a structure in which the assembling light frames 31 are assembled with each other, the assembling bodies 312 are further provided with clamping structures. This can further form a stable assembled structure.

Further, end portions of the light frame bodies 311 are abutted with each other, and the assembling bodies 312 are clamped with each other. In this embodiment, the end portions of the light frame bodies 311 are abutted to form a continuous overall structure. The assembling bodies 312 are clamped with each other to keep the structures of the assembling light frames 31 stable. It can be understood that in other embodiments, clamping structures can be arranged at the end portions of the light frame bodies, without additionally increasing distances between the end portions.

Specifically, each assembling body 312 includes an assembling wall 3121 flush with an end portion of the light frame body 311 corresponding to the assembling body 312. The assembling wall 3121 is provided with a clamping structure. The assembling walls 3121 of the assembling bodies are clamped with each other through the clamping structures.

Further, each connection frame 32 is configured as a hollow structure, and the two assembling bodies 312 corresponding to the connection frame 32 are adaptively connected and assembled to the connection frame 32. Specifically, two adjacent assembling bodies 312 are combined into a whole and are sleeved into the connection frame 32 to form a stable assembled structure. Specifically, interference fitting, snap-in connection, or the like can be used for connection and fitting.

Further, the connection frame 32 is provided with a mounting port 321 facing a corresponding one of the light frame bodies 311. A middle portion of the mounting port 321 inwards extends to form a limiting strip 322. Two sides of the limiting strip 322 are respectively received within the two assembling bodies 312 corresponding to the connection frame 32. In this embodiment, the two sides of the limiting strip 322 and an inner side wall of the connection frame 32 form a receiving space capable of correspondingly receiving one of the assembling bodies 312. In this way, the two corresponding assembling bodies 312 do not require an additional mutual connection structure.

In another embodiment, the two assembling bodies 312 corresponding to the connection frame 32 are assembled with each other to jointly form a mounting hole 3122. The connection frame 32 is provided with a through hole 323 corresponding to the mounting hole. A locking member 34 passes through the through hole 323 and is locked to the mounting hole 3122.

In another embodiment, the assembling bodies 312 are provided with mounting holes. The connection frame 32 is provided with a through hole corresponding to the mounting holes. A locking member passes through the through hole and is locked to the mounting holes. In this embodiment, each assembling body 312 is provided with the mounting hole, and the connection frame 32 is assembled and connected to each assembling body 312 through the locking member. This further enhances stability of assembling.

According to the assembled fan light 100 provided in the present disclosure, in one aspect, the fan blade assembly 20 is configured to be detachably connected to the central assembly 10, thus implementing convenient mounting and removal of the fan blade assembly 20. In another aspect, the light frame assembly 30 is formed into an intact circular continuous assembled structure by the assembling light frames 31 and is assembled and connected to the central assembly 10 through the connection frames 32, thus implementing convenient mounting and removal of the light frame assembly 30. To facilitate folding and storage of the assembled fan light 100, a storage volume of the assembled fan light 100 is reduced, thus avoiding transportation damage and reducing transportation costs. The operation is convenient. During use, light sources of the light frames are continuous, thus providing a good user experience.

In the description of this specification, the description referring to the terms “one embodiment”, “some embodiments”, “an example”, “specific examples”, “some examples”, or the like means that specific features, structures, materials or characteristics described in connection with the embodiments or examples are included in at least one embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples. In addition, those skilled in the art may combine the different embodiments or examples described in this specification, as well as the features of different embodiments or examples, without mutual contradictions.

Although the embodiments of the present disclosure have been shown and described, it can be understood by those of ordinary skill in the art that various changes, modifications, substitutions variations can be made to these embodiments without departing from the principle and concept of the present disclosure. The scope of the present disclosure is defined by the claims and their equivalents.

What is claimed is:

1. An assembled fan light, comprising:
a central assembly comprising a housing and a control mechanism mounted inside the housing, wherein the housing is capable of being connected to an external mounting structure;
a fan blade assembly detachably in pivotal connection to the control mechanism; and
a light frame assembly comprising at least two assembling light frames and at least two connection frames, wherein each assembling light frame comprises an arc-shaped light frame body and two assembling bodies which extend towards a circle center of an arc respectively from two ends of the light frame body; the at least two light frame bodies are connected in sequence end-to-end to form a whole circle structure; two correspondingly adjacent assembling bodies of the at least two assembling light frames are adaptively connected to each other and are detachably connected to one end of one of the connection frames; and another end of the connection frame is detachably connected to the housing.

2. The assembled fan light according to claim 1, wherein each light frame body comprises two end walls located at two ends, a side wall connected between the two end walls, and a light board with a lower side adaptively connected to the side wall and the two end walls; the end walls of each light frame body are correspondingly connected to the end walls of another light frame body; and the assembling bodies are connected to an end portion of the side wall and are flush with the end walls corresponding to the assembling bodies.

3. The assembled fan light according to claim 2, wherein the side wall of each light frame body comprises a first side wall located on an inner side and a second side wall opposite to the first side wall; each light frame body further comprises a cover plate with an upper side covering the first side wall, the second side wall, and the two end walls; a lower side of the light board is adaptively connected to the first side wall, the second side wall, and the two end walls; and the assembling bodies are connected to an end portion of the first side wall and are flush with the end walls corresponding to the assembling bodies.

4. The assembled fan light according to claim 3, wherein the first side wall is provided with a wire passing opening corresponding to one assembling body; the assembling body is configured as a hollow structure; the light board is provided with a terminal cable corresponding to the wire passing opening; and the terminal cable is electrically connected to the control mechanism via the wire passing opening, the assembling body, and a corresponding one of the connection frames.

5. The assembled fan light according to claim 2, wherein the light frame assembly further comprises a lampshade correspondingly arranged on the lower side of the light board; and/or,
the end walls of the assembling light frames are abutted with each other; the assembling bodies of the light frame bodies are clamped with each other; and the light boards of the light frame bodies are abutted with each other.

6. The assembled fan light according to claim 1, wherein end portions of the light frame bodies are abutted with each other, and corresponding assembling bodies are clamped with each other.

7. The assembled fan light according to claim 6, wherein each assembling body comprises an assembling wall flush with an end portion of the light frame body corresponding to the assembling body; the assembling wall is provided with a clamping structure; and the assembling walls of the assembling bodies are clamped with each other through the clamping structures.

8. The assembled fan light according to claim 1, wherein each connection frame is configured as a hollow structure, and the two assembling bodies corresponding to the connection frame are adaptively connected and assembled to the connection frame.

9. The assembled fan light according to claim 8, wherein the connection frame is provided with a mounting port facing a corresponding one of the light frame bodies; a middle portion of the mounting port inwards extends to form a limiting strip; and two sides of the limiting strip are respectively received within the two assembling bodies corresponding to the connection frame.

10. The assembled fan light according to claim 8, wherein the two assembling bodies corresponding to the connection frame are assembled with each other to jointly form a mounting hole; the connection frame is provided with a through hole corresponding to the mounting hole; a locking member passes through the through hole and is locked to the mounting hole; or,
the assembling bodies are provided with mounting holes; the connection frame is provided with a through hole corresponding to the mounting holes; and a locking member passes through the through hole and is locked to the mounting holes.
